(19) United States
(12) Patent Application Publication
(10) Pub. No.: US 2024/0407470 A1
(43) Pub. Date: Dec. 12, 2024

(54) CLEANING TOOL FOR AEROSOL-GENERATING DEVICE

(71) Applicant: PHILIP MORRIS PRODUCTS S.A., Neuchâtel (CH)

(72) Inventor: Dani RUSCIO, Cressier (CH)

(21) Appl. No.: 18/700,900

(22) PCT Filed: Oct. 14, 2022
(86) PCT No.: PCT/IB2022/059836

§ 371 Date: Apr. 12, 2024

(30) Foreign Application Priority Data
Oct. 15, 2021 (EP) 21202837.7

(51) Int. Cl. A24F 40/85; A24F 40/46; B08B 9/00

(52) U.S. Cl. CPC A24F 40/85; A24F 40/46; B08B 9/00

(57) ABSTRACT

A tool for cleaning an aerosol-generating device having a heating chamber, the tool includes a tool base, a first elongate member, a second elongate member, and one or more elongate member protrusions. The first elongate member extends from the tool base. The first elongate member includes a first distal end distal from the tool base. The second elongate member extends from the tool base. The second elongate member includes a second distal end distal from the tool base. A slot is defined between the first elongate member and the second elongate member. The one or more elongate member protrusions are configured to cause the first elongate member and the second elongate member to move towards one another to reduce a width of the slot when a cleaning action is applied to the tool.

The present disclosure relates to a cleaning tool for an aerosol-generating device. In particular, the invention relates to a cleaning tool for cleaning at least a heating chamber of an aerosol-generating device.

Aerosol-generating articles in which an aerosol-forming substrate for generating an inhalable aerosol is heated, rather than combusted, are known in the art. Typically in such heated aerosol-generating articles, an aerosol is generated by the transfer of heat from a heat source to a physically separate aerosol-forming substrate or material. The aerosol-forming substrate may be located within, around, or downstream of the heat source. During use, volatile compounds are released from the aerosol-forming substrate by heat transfer from the heat source and entrained in air drawn through the aerosol-generating article. As the released compounds cool, they condense to form an aerosol.

International patent publication WO 2013/102614 discloses an example of an electrically operated aerosol-generating device in which an aerosol-forming substrate of an aerosol-generating article is heated in direct contact with a heating blade to form an inhalable aerosol. The heating blade is in the form of a blade which extends from a bottom chamber wall of a heating chamber. The heating blade is inserted into an aerosol-forming substrate segment of an aerosol-generating article.

When an aerosol-forming substrate, such as a tobacco substrate, is heated, volatile compounds are released. Some of the volatile compounds and aerosol evolved by the heat from the heating blade may become deposited on the aerosol-generating device. In particular, such residue may become deposited on the bottom chamber wall of the heating chamber, whereas residue on the side walls of the heating chamber may be at least partially removed by the insertion and removal on the aerosol generating article. Particles of the aerosol-forming substrate itself may also become adhered to the heating blade, particularly if the heating blade is in direct contact with the aerosol-forming substrate. For example, when using the device described in WO2013/102614, a heating blade warms a tobacco substrate to temperatures between 200 to 350 degrees Celsius, releasing volatile compounds, nicotine and glycerol that can form an aerosol. Residues and dust may nevertheless collect inside the heating chamber in the device after use of multiple aerosol-generating articles.

Residue and dust accumulation on the chamber bottom wall can block air flow passageways of the aerosol-generating device. Furthermore, the heating blade is susceptible to damage if improper tools or objects are used to clean the heating chamber.

According to an aspect of the present invention, there is provided a tool for cleaning an aerosol-generating device having a heating chamber. The tool may comprise a tool base. The tool may comprise first elongate member and the second elongate member extending from the tool base. The first elongate member may comprise a first distal end distal from the tool base. The second elongate member may comprise a second distal end distal from the tool base. A slot may be defined between the first elongate member and the second elongate member. The tool may comprise one or more elongate member protrusions configured to cause the first elongate member and the second elongate member to move towards one another to reduce a width of the slot when a cleaning action is applied to the tool.

Advantageously, the first elongate member and the second elongate member may allow the tool to clean the heating chamber at a bottom wall near the base of the chamber. Additionally, the one or more elongate member protrusions may allow the elongate members to clean the bottom wall closer to the heating element without risking damage to the heating element during cleaning actions. The tool may also serve to clean the heating element. Preferably, the heating element is an elongate heating element. Preferably, the elongate heating element is a heating blade.

Preferably, reciprocating movement of the at least one of the first distal end of the first elongate member and the second distal end of the second elongate member, within the heating chamber, may be configured to scrape the bottom chamber wall. As used herein the term “reciprocating movement”, in the context of one or both of a first distal end of a first elongate member and a second distal end of a second elongate member within a heating chamber having an elongate heating element extending into the heating chamber, refers to an angular movement that is generally parallel to the plane the heating element is in. The angular movement may be initiated by moving the tool base in a direction parallel to the heating element and the slot. In response, the first elongate member and the second elongate member may move in a direction opposite the movement of the tool base causing one or both of the first distal end and the second distal end to scrape the chamber bottom wall in a pivoting motion.

The tool may comprise a tubular member surrounding at least a portion of the first elongate member and the second elongate member. The tubular member may comprise a first semi-cylindrical shell and a second semi-cylindrical shell. The first semi-cylindrical shell and second semi-cylindrical shell may be configured to couple to one another to form a tube. The tubular member may comprise one or more channels on an outer surface of the tubular member. The one or more channels may extend parallel to a longitudinal axis of the tubular member. The one or more channels may be configured to receive a rib of the heating chamber. The tubular member may comprise one or more tubular member protrusions on an inner surface of the tubular member. Each of the one or more tubular member protrusions may be configured to engage a corresponding one of the one or more elongate member protrusions.

The tubular member, or a portion of the tubular member, may have an outer shape and dimension similar to an inner shape and dimension of the heating chamber into which the tubular member may be inserted. Having such a similar shape and dimension may facilitate insertion of the tubular member into the heating chamber. Having such a similar shape and dimension may facilitate alignment of the tubular member with the heating chamber. Proper alignment of the tubular member with the heating chamber may result in proper alignment of the slot defined between the first elongate member and the second elongate members with the elongate heating element, such as a heating blade, if the device has a heating element.

The tubular member may define an outer circumference with at least one channel configured to receive a rib of the heating chamber. Engagement of the rib with the channel may prevent axial rotation of the first elongate member and the second elongate member within the heating chamber. Preventing axial rotation may advantageously prevent the elongate heating element, such as a heating blade, from being broken off. The at least one channel may be flared at a receiving end. Providing at least one channel with a flared receiving end may advantageously facilitate alignment of the tool and insertion of the tool into the heating chamber

The one or more elongate member protrusions may be rounded elongate member protrusions. The one or more elongate member protrusions may comprise a first pair of elongate member protrusions connected to each other by a first base and extending from the first elongate member. The elongate member protrusions of the first pair of elongate member protrusions may be spaced apart by a first gap located adjacent to the base and between the elongate member protrusions of the first pair of elongate member protrusions. The one or more elongate member protrusions may comprise a second pair of elongate member protrusions connected to each other by a second base and extending from the second elongate member. The elongate member protrusions of the second pair of elongate member protrusions may be spaced apart by a second gap located adjacent to the second base and between the elongate member protrusions of the second pair of elongate member protrusions.

At least a portion of one of the one or more elongate member protrusions may extend through the tubular member. At least one of the one or more elongate member protrusions may be configured to engage with an inner wall of a heating chamber of an aerosol generating device. The portion of the one or more elongate member protrusions that extend through the tubular member may be configured to engage with an inner wall of the heating chamber. Each of the one or more channels of the tubular members may extend through the first gap or the second gap.

The tool may include a pivot member arranged between the base and both the first distal end of the first elongate member and the second distal end of the second elongate member. The pivot member may be configured to allow pivoting the first elongate member and the second elongate member in a preferred direction transverse to the extension of the first elongate member. The pivot member may be configured to limit pivoting the first elongate member and the second elongate member in a non-preferred direction. The non-preferred direction may include any direction that includes a component orthogonal to the preferred direction. Preferably, the pivot member is configured to prevent movement of the first elongate member and the second elongate member within the heating chamber that may damage the heating element if the tool is used to clean a device having an elongate heating element, such as a heating blade, extending into a heating chamber.

The pivot member may define one or more extensions extending from an outer surface of at least one of the first elongate member and the second elongate member. The one or more extensions may be cylindrical extensions. Preferably, the pivot member may define two extensions. One of the two extensions may extend from an outer surface the first elongate member and the second extension may extend from an outer surface of the second elongate member. The outer surface of the first elongate member may face away from the slot. The outer surface of the second elongate member may face away from the slot. The tubular member may include one or more receptacles each configured to receive a extension. The one or more receptacles may define a hollow cylinder with at least one open face. The one or more receptacles and the extensions may be configured to cooperate to allow the first elongate member and the second elongate member to be pivoted in the preferred direction. The one or more receptacles and the extensions may be configured to cooperate to prevent the first elongate member and the second elongate member from being pivoted in the non-preferred direction

The pivot member, or a portion of the pivot member, may define an outer perimeter having one or more channels configured to receive a rib of the heating chamber as the pivot member is inserted into the heating chamber. When the rib is received in the channel, axial rotation within the heating chamber of the first elongate member and the second elongate member may be limited. The one or more channels may be flared at a receiving end. Providing one or more channels with a flared receiving end may advantageously facilitate alignment of the tool and insertion of the tool into the heating chamber.

The pivot member, or a portion of the pivot member, may have an outer shape and dimension similar to an inner shape and dimension of the heating chamber into which the pivot member may be inserted. Having such a similar shape and dimension may facilitate insertion of the pivot member into the heating chamber. Having such a similar shape and dimension may facilitate alignment of the pivot member with the heating chamber. Proper alignment of the pivot member with the hating chamber may result in proper alignment of the slot defined between the first elongate member and the second elongate member with the heating element if the device has an elongate heating element, such as a heating blade.

The pivot member may comprise an elliptical member defining an outer circumference with at least one channel configured to receive a rib of the heating chamber. Engagement of the rib with the channel may prevent axial rotation of the first elongate member and the second elongate member within the heating chamber. The elliptical member may comprise a disk or a cylinder. The elliptical member may be in the shape of an ellipse. The shape of an ellipse may include a circular shape. The at least one channel may be flared at a receiving end. Providing at least one channel with a flared receiving end may advantageously facilitate alignment of the tool and insertion of the tool into the heating chamber.

The pivot member may be integrally formed with the tool base, the first elongate member, and the second elongate member. The pivot member may be firmly coupled between the base and both the first distal end and the second distal end. The pivot member may be formed from any suitable material. For example, the pivot material may be formed from a metallic material, a plastic material, or a combination of a metallic material and a plastic material.

The elongate members may be configured to pivot between a neutral position to a first pivoted position in the preferred direction or between a neutral position and a second pivoted position in the preferred direction. The first pivoted position and the second pivoted position may be on opposite sides of the neutral position along the preferred direction. Pivoting of the elongate members may be initiated by a reciprocating motion.

The one or more tubular member protrusions of the tubular member may comprise a first tubular member protrusion configured to engage the first pair of elongate member protrusions and a second tubular member protrusion configured to engage the second pair of elongate member protrusions. An apex of the first tubular member protrusion may be located in the first gap when the elongate members are in the neutral position. An apex of the second tubular member protrusion may also be located in the second gap in the neutral position. The apex of the first tubular member protrusion may be configured to engage one of the elongate member protrusions of the first pair of elongate member protrusions when the first elongate member is in the first or second position. The apex of the second tubular member protrusion may be configured to engage one of the second pair of elongate member protrusions when the second elongate member is in the first or second position.

The tool may include bristles extending from the first elongate member, the second elongate member or both of the first elongate member and the second elongate member. The bristles may advantageously increase the effective cleaning area of the tool. Preferably, the bristles are sufficiently stiff to clean a surface of the heating chamber but are not sufficiently stiff to cause damage to an elongate heating element extending into the heating chamber. The bristles will preferably contact a surface and deflect from the surface of the heating chamber or the elongate heating element when the tool is being used to clean the heating chamber.

The bristles may extend radially outward from one or both of the first elongate member and the second elongate member. Bristles extending radially outward may advantageously clean inner circumferential surfaces of the heating chamber.

The bristles may be formed from any suitable material. For example, the bristles may be formed from metallic filament, plastic filaments, or filaments comprising a metallic material and a plastic material.

The tool base, the first elongate member, and the second elongate member may be integrally formed. The first elongate member and the second elongate member may be coupled to the tool base. The tool base, the first elongate member, and the second elongate member may be formed from any suitable material. For example, one or more of the tool base, the first elongate member, and the second elongate member may be formed from a metallic material, a plastic material, or a combination of a metallic material and a plastic material.

The first elongate member may include a first flat surface facing the slot and the second elongate member may include a second flat surface facing the slot, the first flat surface extending through a first plane and the second flat surface extending through a second plane, wherein the first plane and the second plane are parallel planes and the first flat surface and second flat surface extend parallel to one another. Providing a tool having a first elongate and a second elongate member with such flat inner surfaces may prevent the first elongate member and second elongate member from damaging the elongate heating element when the chamber bottom wall is scraped with the tool. Such an arrangement of flat inner surfaces of the first elongate member and the second elongate member may be particularly useful in preventing damage if the tool is configured to prevent axial rotation when the chamber bottom wall is being scraped. For example, axial rotation may be inhibited by providing a channel along an outer perimeter of a pivot element, where the channel is configured to receive a rib of the heating chamber.

At least one of the first elongate member and the second elongate member may include one or more ridges on a surface facing the slot. The one or more ridges may be configured to collapse at a threshold level of torque or flexion. The one or more ridges may be formed of elastically deformable material. The one or more ridges may advantageously clean a surface of the elongate heating element while the bottom chamber wall is being scraped or cleaned. Furthermore, ridges configured to collapse or ridges formed of elastically deformable material may provide additional protection against damage to the elongate heating element.

The tool base may include a handle. The handle may extend in a direction away from the first distal end of the first elongate member. For example, the handle may extend away from the first distal end of the first elongate member along a longitudinal axis of the tool.

One or both of the first distal end and second distal end may have a tapered shape. For example, one or both of the first distal end and the second distal end may be narrower than a portion one or both of the first distal end and second distal end closest to the tool base. The tapered shape may facilitate scraping the chamber bottom wall.

The tool may include a cap. The cap may be configured to couple with the aerosol-generating device. The tool may be configured such that one or both of the first elongate member and the second elongate member contact the bottom wall when the cap is coupled with the aerosol-generating device. At least a portion of the cap may be configured to receive a portion of the aerosol-generating device when the first elongate member and second elongate members are received in the heating chamber of the aerosol-generating device.

The cap may be formed from any suitable material. For example, the cap may be formed from a metallic material, a plastic material, or a metallic material and a plastic material.

The tool may comprise a rod that effectively couples the first elongate member and the second elongate member to the cap. The rod may allow reciprocating movement of the first elongate member and the second elongate member. The rod may prevent axial rotation of the first elongate member and the second elongate member. For example, the rod may effectively couple the first elongate member and second elongate member to the cap such that the first elongate member and second elongate member may pivot about the rod. Providing the tool with a cap and a rod may advantageously provide controlled and consisting cleaning of the chamber bottom wall near the elongate heating element. The cap and rod may also inhibit damage to a heating element, if the device includes an elongate heating element, such as a heating blade, extending into the heating chamber, because the cap and rod may inhibit axial rotation of the first elongate member and the second elongate member. If the device includes an elongate heating element, the cap, or another element of the tool, preferably comprises a feature configured to mate with a corresponding feature of the aerosol generating device to facilitate proper alignment of first elongate member and second elongate member relative to the elongate heating element.

The rod may be formed from any suitable material. For example, the rod may be formed from a metallic material, a plastic material, or a metallic material and a plastic material.

The tool base may include a cleaning head for cleaning the aerosol-generating device. The cleaning head may be positioned at an opposing end of the tool relative to the first distal end of the first elongate member. When the cleaning head is inserted into the heating chamber towards the bottom wall, the distal end of the first elongate member extends away from the bottom wall. Preferably, the cleaning head is configured to clean areas of the bottom surface of the heating chamber that the first distal end of the first elongate member and the second distal end of the second elongate member may not reach. The cleaning head may include scraping surfaces for cleaning the bottom surface of the heating chamber. A tool with a cleaning head opposing the first distal end of the first elongate member and the second distal end of the second elongate member may advantageously be used to better clean the heating chamber than a tool without the cleaning head.

Preferably, the first elongate member and a second elongate member are moveable laterally to adjust the width of the slot at the distal end of the tool during a cleaning action. For example, the first elongate member and the second elongate member may be moved to decrease the slot width at the distal end of the tool during insertion of the tool into the heating chamber after the elongate heating element is received in the slot. Further, for example, the first elongate and may be moved to decrease the width of the slot at the distal end of the tool as the first elongate member and the second elongate member are pivoted from the neutral position to the first or second pivoted positions. Such lateral adjustment of the width of the slot may allow the first elongate member and second elongate member to be inserted in the heating chamber over an elongate heating element, such as a heating blade, without damaging the heating element during insertion. Thus, the tool can easily accommodate the elongate heating element during insertion and be moved into place to scrape or clean the bottom chamber wall near the elongate heating element after insertion.

The elongate members may include tapered sides. Tapered sides may advantageously allow an elongate heating element to more easily pass between the elongate members providing additional protection against damage to the heating element during the reciprocating motion. The distal ends of the elongate member may be tapered. Tapered distal ends may allow the elongate heating element to more easily pass between the distal ends during insertion of the tool into a heating chamber providing additional protection against damage to the heating element.

The cleaning action may be insertion of the tool into the heating chamber. The cleaning action may be pivoting the first elongate member and the second elongate member in the preferred direction.

A system may comprise an aerosol-generating device and the tool for cleaning the aerosol-generating device. The aerosol-generating device may comprise a heating chamber and an elongate heating element with a substantially rectangular cross section extending into the heating chamber from a bottom chamber wall of a heating chamber.

Advantageously, a system including the cleaning tool provided with the first elongate member and the second elongate member defining a slot therebetween allows the tool to scrape or clean the chamber bottom wall of the aerosol-generating device near the base of the heating element. Preferably, the use of the tool to clean the heating chamber does not damage the elongate heating element. The tool may also serve to clean the heating element.

According to another aspect of the present invention, there is provided a method comprising inserting a tool comprising elongate members defining a slot between the elongate members into a heating chamber of an aerosol-generating device. The method may comprise receiving an elongate heating element of the aerosol-generating device is received into the slot and an end of the elongate members contact a bottom chamber wall of the heating chamber. The method may also comprise scraping the bottom chamber wall with the end of the elongate members by moving the ends of the elongate members using a reciprocating movement.

Preferably, scraping or cleaning of the bottom chamber wall with the end of the elongate members may be achieved without damaging the elongate heating element of the aerosol-generating device. Damage to the heating element can be prevented if the tool and the device are configured to interact to prevent axial rotation of the first elongate member and second elongate member when the elongate members are received in the heating chamber. For example, axial rotation of the first elongate member and the second elongate member may be inhibited by providing a channel along an outer perimeter of a pivot element, where the channel is configured to receive a rib of the heating chamber. As another example, axial rotation of the first elongate member and the second elongate member may be inhibited by providing a cap configured to align with the device and a rod effectively coupling the first elongate member and the second elongate member to the cap.

The method may include reducing the width of the slot defined by the first elongate member and the second elongate member after the elongate heating element has been received in the slot while the tool is inserted into the heating chamber. The width of the slot may be reduced when one or more elongate member protrusions of the tool engage with an inner wall of the heating chamber.

The method may include reducing the width of the slot as the first elongate member and the second elongate member are pivoted from a neutral position to a first pivoted position or a second pivoted position. The wide of the slot may be reduced when one or more elongate member protrusions of the tool slide along a tubular member protrusion located on an inner surface of a tubular element surrounding the first elongate member and the second elongate member.

The invention is defined in the claims. However, below there is provided a non-exhaustive list of non-limiting examples. Any one or more of the features of these examples may be combined with any one or more features of another example, embodiment, or aspect described herein.

Example Ex1: A tool for cleaning an aerosol-generating device having a heating chamber, the tool comprising: a tool base; a first elongate member extending from the tool base, the first elongate member comprising a first distal end distal from the tool base; a second elongate member extending from the tool base, the second elongate member comprising a second distal end distal from the tool base, wherein a slot is defined between the first elongate member and the second elongate member; and one or more elongate member protrusions operatively coupled to the first elongate member or the second elongate member and configured to cause the first elongate member and the second elongate member to move towards one another to reduce a width of the slot when a cleaning action is applied to the tool.

Example Ex2: The tool of example Ex1, further comprising a tubular member surrounding at least a portion of the first elongate member and the second elongate member.

Example Ex3: The tool of example Ex2, wherein the tubular member comprises: a first semi-cylindrical shell; and a second semi-cylindrical shell, wherein the first semi-cylindrical shell and second semi-cylindrical shell are configured to couple to one another to form a tube.

Example Ex4: The tool of any one of examples Ex2 or Ex3, wherein the tubular member further comprises one or more channels on an outer surface of the tubular member, the one or more channels extending parallel to a longitudinal axis of the tubular member.

Example Ex5: The tool of any one of examples Ex2 to Ex4, wherein the tubular member further comprises one or more tubular member protrusions on an inner surface of the tubular member, each of the one or more tubular member protrusions configured to engage a corresponding one of the one or more elongate member protrusions.

Example Ex6: The tool of any one of examples Ex2 to Ex4, wherein at least a portion of one of the one or more elongate member protrusions extends through the tubular member.

Example Ex7: The tool of any one of examples Ex2 to Ex6, wherein each of the one or more elongate member protrusions are rounded elongate member protrusions.

Example Ex8: The tool of any one of the preceding examples, wherein the one or more elongate member protrusions comprises: a first pair of elongate member protrusions connected to each other by a first base and extending from the first elongate member, wherein elongate member protrusions of the first pair of elongate member protrusions are spaced apart by a first gap located adjacent to the base and between the elongate member protrusions of the first pair of elongate member protrusions; and a second pair of elongate member protrusions connected to each other by a second base and extending from the second elongate member, wherein elongate member protrusions of the second pair of elongate member protrusions are spaced apart by a second gap located adjacent to the second base and between the elongate member protrusions of the second pair of elongate member protrusions.

Example Ex9: The tool of example Ex8, wherein each of the one or more channels of the tubular member extends through the first gap or the second gap.

Example Ex10: The tool of example Ex8, wherein at least one of the one or more elongate member protrusions is configured to engage with an inner wall of a heating chamber of an aerosol generating device.

Example Ex11: The tool of example Ex8, wherein the one or more tubular member protrusions comprise: a first tubular member protrusion configured to engage the first pair of elongate member protrusions; and a second tubular member protrusion configured to engage the second pair of elongate member protrusions.

Example Ex12: The tool of any one of the preceding examples, further comprising one or more pivot members arranged between the tool base and both the first distal end of the first elongate member and the second distal end of the second elongate member, wherein the one or more pivot members is configured to allow pivoting the first elongate member and the second elongate member in a preferred direction transverse to the extension of the first elongate member and wherein the one or more pivot members is configured to limit pivoting the first elongate member and the second elongate member in a non-preferred direction.

Example Ex13: The tool of any one of the preceding examples, wherein the first elongate member and the second elongate member are configured to pivot between a neutral position to a first pivoted position in the preferred direction or between a neutral position and a second pivoted position in the preferred direction, the first pivoted position and the second pivoted position being on opposite sides of the neutral position along the preferred direction.

Example Ex14: The tool of example Ex13, wherein an apex of the first tubular member protrusion is located in the first gap when the first elongate member and the second elongate member are in the neutral position and an apex of the second tubular member protrusion is located in the second gap in the neutral position.

Example Ex15: The tool of example Ex14, wherein the apex of the first tubular member protrusion is configured to engage one of the elongate member protrusions of the first pair of elongate member protrusions when the first elongate member is in the first or second position and the apex of the second tubular member protrusion is configured to engage one of the second pair of elongate member protrusions when the second elongate member is in the first or second position.

Example Ex16: The tool of any one of the preceding examples, wherein a surface facing the slot of the first elongate member and a surface facing the slot of the second elongate member are configured to engage opposite sides of an elongate heating element when the slot is narrowed while the tool is received in a heating chamber of an aerosol generating device.

Example Ex17: The tool according to any one of examples Ex12 to Ex16, wherein the one or more pivot members comprises an elliptical member defining an outer circumference with a channel configured to engage with a rib of the heating chamber to prevent axial rotation of the first elongate member and the second elongate member within the heating chamber.

Example Ex18: The tool according to example Ex17, wherein the elliptical member comprises a disk or a cylinder.

Example Ex19: The tool according to any one of the preceding examples, wherein the tool further comprises bristles extending from the first elongate member and the second elongate member.

Example Ex20: The tool according to example Ex19, wherein the bristles extend from the first elongate member and the second elongate member radially outward.

Example Ex21: The tool according to any one of the preceding examples, wherein the first elongate member comprises a first flat surface facing the slot and the second elongate member comprises a second flat surface facing the slot, the first flat surface extending through a first plane and the second flat surface extending through a second plane, wherein the first plane and the second plane are parallel planes and the first flat surface and the second flat surface extend parallel to one another.

Example Ex22: The tool according to any one of examples Ex1 to Ex20, wherein at least one of the first elongate member and the second elongate member comprises one or more ridges on a surface facing the slot.

Example Ex23: The tool according to any one of the preceding examples, wherein the tool base comprises a cleaning head for cleaning the heating chamber of the aerosol-generating device, the cleaning head comprising one or more scraping surfaces.

Example Ex24: The tool according to any one of the preceding examples, wherein the cleaning action comprises insertion of the tool into the heating chamber.

Example Ex25: The tool according to any one of the preceding examples, wherein the cleaning action comprises pivoting the first elongate member and the second elongate member in the preferred direction.

Example Ex26: A system comprising: an aerosol-generating device comprising a heating chamber and an elongate heating element with a substantially rectangular cross section extending into the heating chamber from a bottom chamber wall of a heating chamber; and a tool for cleaning the aerosol-generating device according to any one of the preceding examples.

Examples will now be further described with reference to the figures in which:

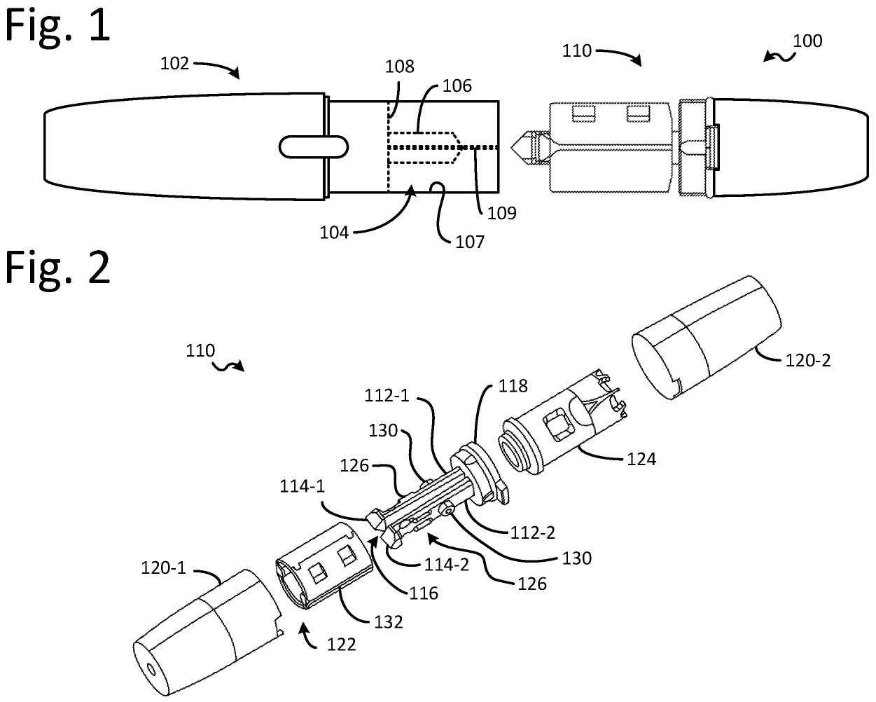

FIG. 1 shows a system including a tool for cleaning an aerosol-generating device;

FIG. 2 shows an exploded view of the tool of FIG. 1;

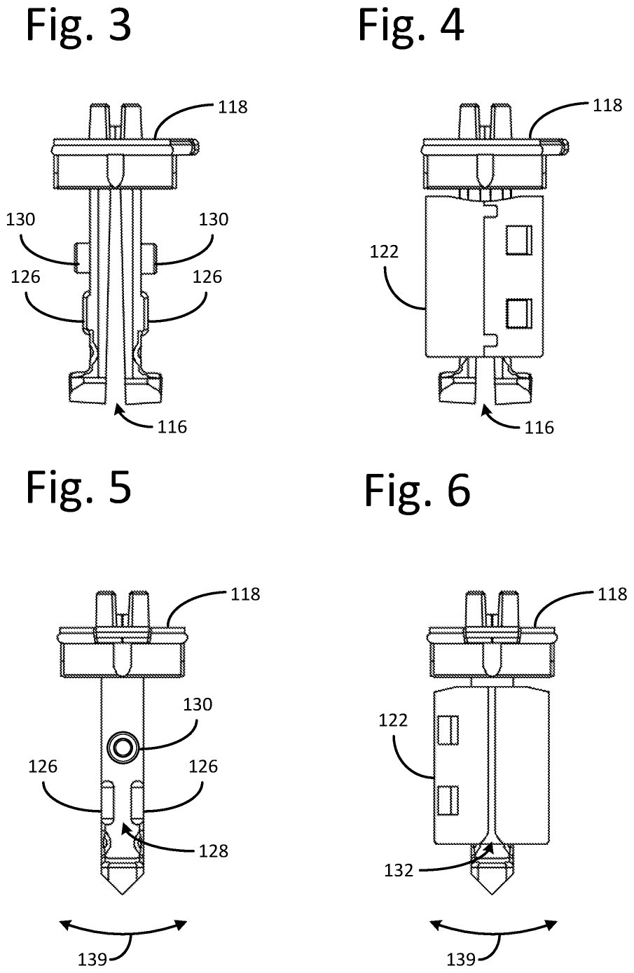

FIG. 3 shows a side view of the tool of FIG. 1 without the caps or tubular member;

FIG. 4 shows a side view of the tool of FIG. 1 without the caps;

FIG. 5 shows another side view of the tool of FIG. 1 without the caps or tubular member;

FIG. 6 shows another side view of the tool of FIG. 1 without the caps;

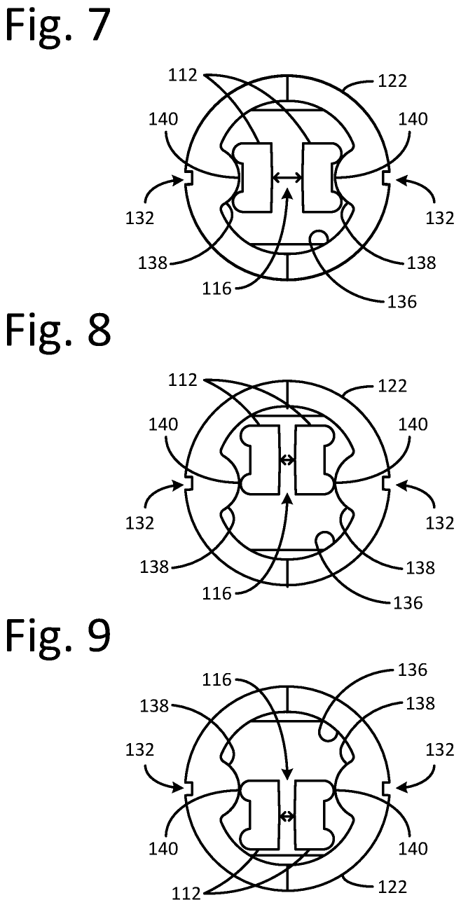

FIG. 7 shows an isometric cross-sectional view of the tool of FIG. 1 with the elongate members in a neutral position;

FIG. 8 shows another isometric cross-sectional view of the tool of FIG. 1 with the elongate members in a first pivoted position;

FIG. 9 shows another isometric cross-sectional view of the tool of FIG. 1 with the elongate members in a second pivoted position;

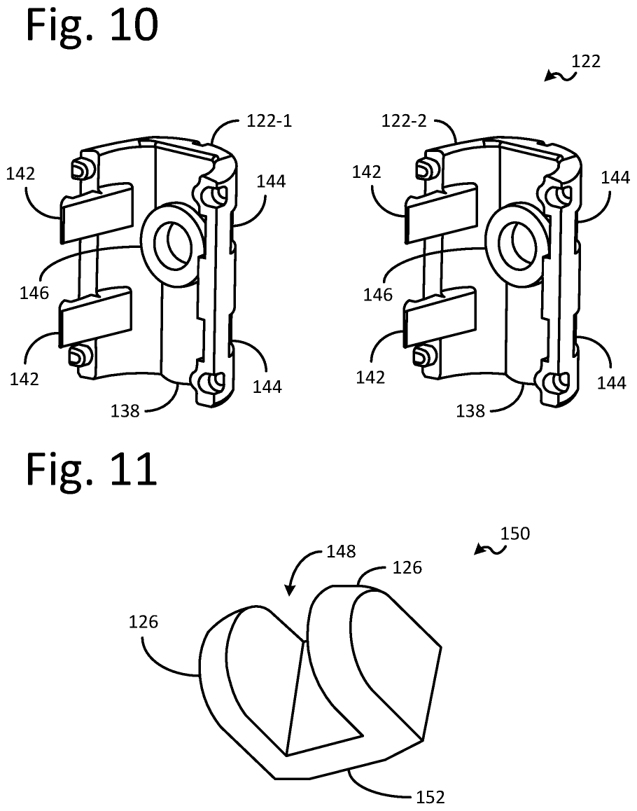

FIG. 10 shows an isometric view of the tubular member with the semi-cylindrical shells separated from one another;

FIG. 11 shows a pair of elongate member protrusions connected by a base;

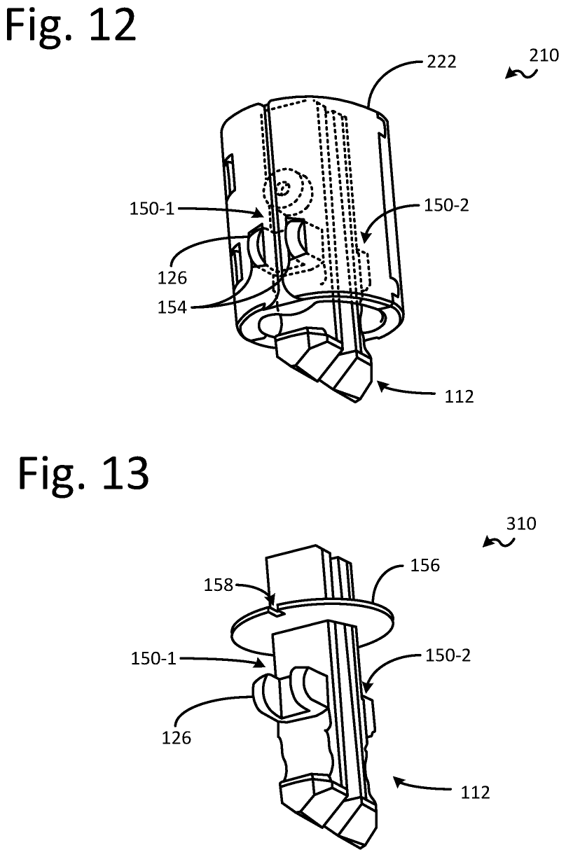

FIG. 12 shows a modification of the tool wherein the elongate member protrusions extend through the tubular member;

FIG. 13 shows another modification of the tool wherein the tool includes an elliptical pivot member;

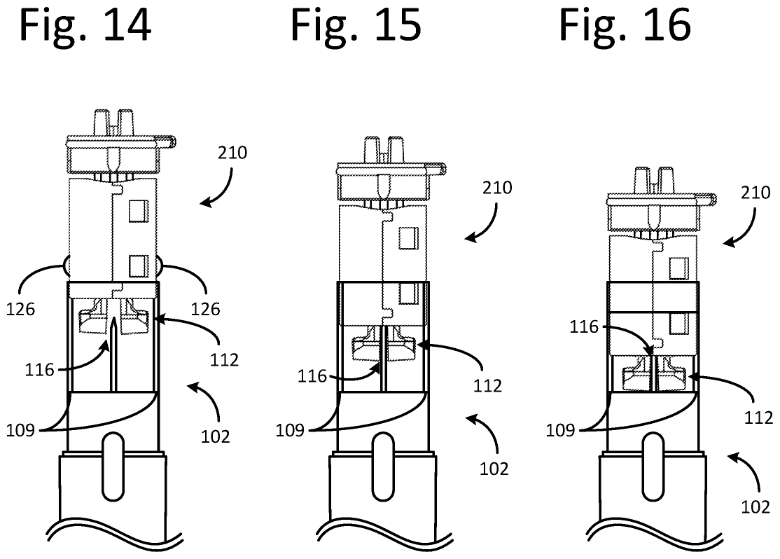

FIG. 14 shows the tool of FIG. 12 as insertion of the tool into a heating chamber of an aerosol-generating device begins;

FIG. 15 shows the tool of FIG. 12 partially inserted into the heating chamber;

FIG. 16 shows the tool of FIG. 12 fully inserted into the heating chamber;

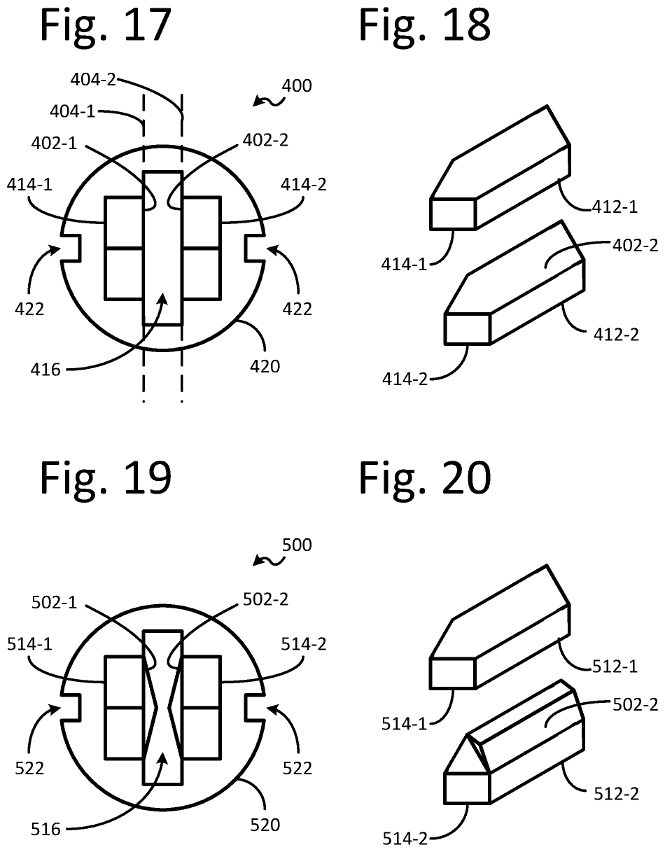

FIG. 17 shows a bottom view of an embodiment of a tool wherein surfaces facing the slot are flat;

FIG. 18 shows an isometric exploded view of a first elongate member and a second elongate member of the tool of FIG. 17;

FIG. 19 shows a bottom view of another embodiment of a tool wherein the surfaces facing the slot include a ridge;

FIG. 20 shows an isometric exploded view of a first elongate member and a second elongate member of the tool of FIG. 19; and

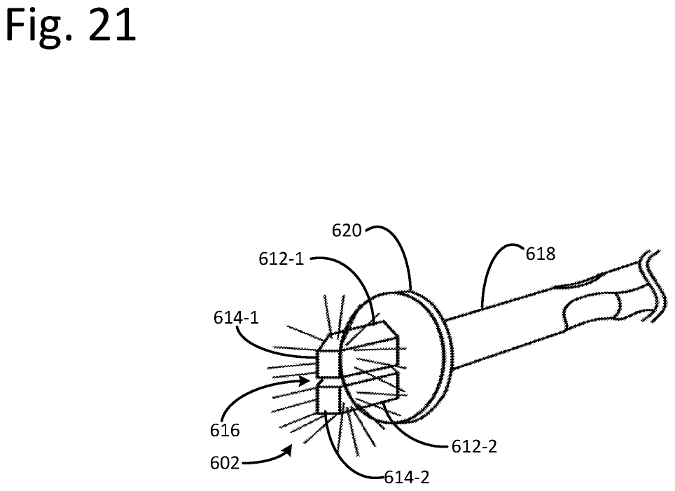

FIG. 21 shows another modification of the tool wherein the elongate members include bristles.

FIGS. 1-6 show a tool 110 for cleaning an aerosol-generating device. FIG. 1 shows system 100 including aerosol-generating device 102 and the tool 110. FIG. 2 shows the tool 110 in an exploded view. FIGS. 3 and 4 show a side view of the tool 110. FIG. 3 shows the tool 110 with the tubular member 122 removed. FIG. 4 shows the tool with the tubular member 122 attached. FIGS. 5 and 6 show a side view of the tool 110 rotated 90 degrees from the view of FIGS. 3 and 4. FIG. 5 shows the tool with the tubular member 122 removed. FIG. 6 shows the tool 110 with the tubular member 122 attached.

The aerosol-generating device 102 includes a heating chamber 104, a heating blade 106, a chamber bottom wall 108, and a rib 109. The heating chamber 104 defines a cavity in the aerosol-generating device 102. The chamber bottom wall 108 is an inner surface of the heating chamber 104. The heating blade 106 extends from the chamber bottom wall 108 into the heating chamber 104. As shown, the heating blade 106 is a blade.

The tool 110 includes a tool base 118, a first elongate member 112-1, a second elongate member 112-2 (referred to collectively as elongate members 112), a first cap 120-1, a second cap 120-2 (referred to collectively as caps 120), a tubular member 122, and an accessory 124, elongate member protrusions 126, and pivot member 130. The elongate members 112 extend from the tool base 118. The first elongate member 112-1 includes a first distal end 114-1 distal from the tool base 118 and the second elongate member 112-2 includes a second distal end 114-2 (referred to collectively as distal ends 114) distal from the tool base 118. A slot 116 is defined between the elongate members 112.

The elongate members 112 are configured to be received in the heating chamber 104 such that the heating blade 106 is received in the slot 116. Additionally, the distal ends 114 extend to the bottom chamber wall 108 such that a reciprocating movement of the distal ends within the heating chamber scrapes the bottom chamber wall. In particular, the reciprocating movement may cause the distal ends 114 scrape the bottom chamber wall adjacent to a base of the heating blade 106. The distal ends 114 may comprise a scraping edge configured to scrape the chamber bottom wall 108. The distal ends 114 may comprise a roughened edge configured to scrape the chamber bottom wall 108.

The elongate members 112 define a slot 116 between them. The open or distal ends 114 of the elongate members 112 are configured to flex in response to pressure exerted on the elongate members 112 in the direction of the slot 116. Such flexure reduces the width of the slot 116 allowing the elongate members 112 to move closer, when compared to the unreduced width of the slot, to the heating blade 106 during a cleaning action. Accordingly, the elongate members 112 can clean the chamber bottom wall 108 near the heating blade 106. Additionally, reducing the width of the slot 116 during a cleaning action may allow the elongate members 112 to clean the heating blade 106.

The elongate member protrusions 126 are coupled to the elongate members 112. The elongate member protrusions 126 are configured to cause the first elongate member 112-1 and the second elongate member 112-2 to move towards one another to reduce a width of the slot 116 when a cleaning action is applied to the tool 110 as shown in FIGS. 7, 8, and 9. The cleaning action may include pivoting the elongate members 112 in the preferred direction. As shown, a pair of elongate member protrusions 126 located on an outer surface of each of the elongate members 112 are spaced apart by a gap 128.

The tubular member 122 surrounds the elongate members 112. The tubular member 122 is shaped to be received in the heating chamber 104. The tubular member 122 may have an outer diameter that corresponds to an inner diameter of the heating chamber. The tubular member 122 includes a channel 132 configured to receive the rib 109. The tubular member 122 cooperates with the rib 109 and the pivot member 130 to prevent axial rotation of the tool 110 when inserted into the heating chamber 104.

As shown, the pivot member 130 includes two cylindrical extensions that extend from surfaces of the elongate members 112 that face away from the slot 116. The cylindrical extensions of the pivot member 130 are received in receptacles 146 (shown in FIG. 10) of the tubular member 122. The pivot member 130 is configured to allow pivoting of the elongate members 112 in a preferred direction transverse to the extension of the elongate members as indicated by arrow 139 depicted in FIGS. 5 and 6. The pivot member 130 is also configured to limit pivoting the elongate members 112 in a non-preferred direction. The pivot member 130 cooperates with receptacle 146 (shown in FIG. 10) of the tubular member 122 to allow the elongate members 112 to pivot in the preferred direction while also limiting or preventing the elongate members 112 from pivoting in non-preferred directions or rotating axially.

The accessory 124 is detachable from the tool base 118. The accessory 124 may couple to the tool base 118 with a snap fit connection. As shown, the accessory 124 is a cleaning head for cleaning the heating chamber 104. Additional accessories that may couple to the tool base 118 include a handle or another cleaning head. The accessory 124 may be operable to pivot the elongate members 112 in the preferred direction.

The caps 120 couple to the tool base 118 to form a housing for the tool 110. The caps 120 may couple to the tool base 118 with a snap fit connection. The first cap 1120-1 is configured to receive and house the elongate members 112 and the tubular member 122. The second cap 120-2 is configured to receive and house the accessory 124.

FIGS. 7-9 show cross-sectional views of the elongate members 112 in various positions relative to the tubular member 122. FIG. 7 shows the elongate members 112 in a neutral position. FIG. 8 shows the elongate members 112 in a first pivoted position. FIG. 9 shows the elongate members 112 in a second pivoted position.

The tubular member 122 includes an inner surface 136. The tubular member protrusions 138 are located on the inner surface 136 of the tubular member 122 and extend inward towards a central longitudinal axis of the tubular member 122. Each of the tubular member protrusions 138 define a convex shape extending out from the inner surface 136 and having an apex 140. The apex 140 of each of the tubular member protrusions 138 is the thickest part of the corresponding tubular member protrusion. In other words, the apex 140 of each of the tubular member protrusions 138 is the point farthest from an outer surface of the tubular member 122.

In the neutral position, an apex 140 of each of the tubular member protrusions 138 is located in one of the gaps 128 between a pair of the elongate member protrusions 126 and the width of the slot 116 is not reduced. The elongate members 112 can be pivoted to the first pivoted position (FIG. 8) or the second pivoted position (FIG. 9) by moving the tool base 118 in a direction parallel to the heating blade 106 and the slot 116. In the first or second pivoted positions, the width of the slot 116 is reduced and the apexes 140 of the tubular member protrusions are engaged with one of the elongate member protrusions 126. As the elongate members 112 are pivoted in the preferred direction to either the first or second pivoted positions, the elongate member protrusions 126 are pushed inward as the elongate member protrusions slide along a profile of the tubular member protrusions 138 towards the apex 140. The pushing action imparted on the elongate member protrusions 126 by the tubular member protrusions 138 causes an inward elastic displacement of the elongate members 112 resulting in a reduction of the width of the slot 116. Accordingly, the reduction in the width of the slot 116 is proportional to a height of the elongate member protrusions 126. Reduction of the width of the slot 116 in this manner maintains a distance from the heating blade 106 while allowing the elongate members 112 to clean closer to the heating blade 106 when the heating blade is not located between the distal ends 114.

FIG. 10 shows the tubular member 122 in an open state. The tubular member 122 includes a first semi-cylindrical shell 122-1 and a second semi-cylindrical shell 122-2. The first semi-cylindrical shell 122-1 and the second semi-cylindrical shell are substantially identical. The first semi-cylindrical shell 122-1 and the second semi-cylindrical shell 122-2 are configured to couple to one another to form a tube. The first semi-cylindrical shell 122-1 and the second semi-cylindrical shell 122-2 include clips 142 and clip receptacles 144 configured to receive and releasably retain the clips 142. Accordingly, the first semi-cylindrical shell 122-1 and the second semi-cylindrical shell 122-2 can couple to one another in a snap fit configuration.

Each of the first semi-cylindrical shell 122-1 and the second semi-cylindrical shell 122-2 includes a tubular member protrusion 138 and a receptacle 146. Each of the tubular member protrusions 138 extends from an edge of one of the first semi-cylindrical shell 122-1 or the second semi-cylindrical shell 122-2 to the receptacle 146. The apex 140 of each of the tubular member protrusions 138 extends parallel to a longitudinal axis of the assembled tubular member 122. Each of the receptacles 146 extends from an inner surface 136 of one of the first semi-cylindrical shell 122-1 or the second semi-cylindrical shell 122-2. Each of the receptacles 146 defines a hollow cylinder with an open end configured to receive one of the cylindrical extensions of the pivot member 130. The receptacles 146 cooperate with the cylindrical extensions to allow the elongate members 112 to pivot in the preferred direction while limiting or preventing axial rotation of the elongate members 112 and preventing pivoting of the elongate members 112 in a non-preferred direction.

FIG. 11 shows a pair of elongate member protrusions 150. The pair of elongate member protrusions 150 includes two elongate member protrusions 126 and a base 152. In contrast with the elongate member protrusions 126 of the tool of FIG. 1, the elongate member protrusions 126 of the pair of elongate member protrusions 150 are connected to one another by the base 152. Each of the elongate member protrusions 126 of the pair of elongate member protrusions 150 extend from opposite sides of the base 152 at one end and are spaced apart by a gap 148 at the other end. The base 152 may be coupled to an elongate member 112 or formed integrally with an elongate member 112.

FIGS. 12 and 13 show different modifications of a tool according to embodiments described herein. FIG. 12 shows a tool 210 that includes elongate member protrusions 126 that extend through a tubular member 222. FIG. 13 shows a tool 310 that includes an elliptical pivot member 156.

Each of the elongate member protrusions 126 of the tools 210 and 310 are configured to engage the inner side wall 107 of the heating chamber 104 of the aerosol-generating device 102. The tubular member 222 of the tool 210 includes openings 154 configured to receive elongate member protrusions 126 and allow the elongate member protrusions to extend past an outer surface of the tubular member 222. The elongate member protrusions 126 extend past the outer surface of the tubular member 222 to allow the elongate member protrusions 126 to engage the inner side wall 107 of the heating chamber 104.

The tool 310 includes an elliptical pivot member 156 but does not include a tubular member. The elliptical pivot member 156 defines an outer circumference with at least one channel 158 configured to receive the rib 109 of the heating chamber 104. Engagement of the rib 109 with the channel 158 may prevent axial rotation of the elongate members 112 within the heating chamber 104. The elliptical pivot member 156 may comprise a disk or a cylinder. Providing at least one channel 158 may advantageously facilitate alignment of the tool and insertion of the tool into the heating chamber 104.

FIGS. 14-16 show a cleaning action that reduces the width of the slot 116 of tool 210 of FIG. 12. Although the cleaning action is depicted with regard to the tool 210, such cleaning action can reduce the width of the slot 116 of other modified tools such as tool 310 of FIG. 13. As shown in FIGS. 14-16, the cleaning action is insertion of the tool 210 into the heating chamber 104 of aerosol-generating device 102. FIG. 14 shows the tool 210 as insertion of the tool into a heating chamber 104 begins. FIG. 15 shows the tool 210 partially inserted into the heating chamber 104. FIG. 16 shows the tool 210 fully inserted into the heating chamber.

As insertion of the tool 210 into the heating chamber 104 begins, the ribs 109 are received into channels 132 of the tubular member 222. However, the elongate member protrusions 126 of the tool do not engage the inner side wall 107 until the tool 210 is further inserted into the heating chamber 104 as shown in FIG. 15. Accordingly, the elongate member protrusions 126 are shown extended past the outer surface of the tubular member 222 in FIG. 14 and the width of the slot 116 is not reduced. The unreduced width of the slot 116 allows the heating blade 106 to be received in the slot 116 without contacting the elongate members 112.

As the tool 210 is inserted farther into the heating chamber 104 the elongate member protrusions 126 engage with the inner side wall 107 and the width of the slot 116 is reduced. As shown in FIG. 15, the elongate member protrusions 126 are no longer visible having been pushed into openings 154. Furthermore, the elongate members 112 are closer to the heating blade 106.

The tool 210 is fully inserted into the heating chamber 104 when the distal ends 114 of the elongate members 112 contact the chamber bottom wall 108 as shown in FIG. 16. When the tool 210 is fully inserted, the elongate member protrusions 126 are still engaged with the inner side wall 107 and the width of the slot 116 is still reduced. Once fully inserted, the distal ends 114 are positioned to scrape and clean the chamber bottom wall 108 when the elongate members 112 are pivoted in the preferred direction. The elongate members 112 may also be positioned to clean the heating blade 106.

FIGS. 17 and 18 show a tool 400 with flat surfaces 402 facing the slot 416 according to embodiments described herein. FIG. 17 shows a bottom view of the tool 400. FIG. 18 shows an isometric exploded view of elongated members 412.

The tool 400 includes a tool base (not shown), a pivot member 420, a first elongate member 412-1, and a second elongate member 412-2 (referred to collectively as elongate members 412). The elongate members 412 extend from the tool base. The first elongate member 412-1 includes a first distal end 414-1 distal from the tool base 418 and the second elongate member 412-2 includes a second distal end 414-2 (referred to collectively as distal ends 414) distal from the tool base 418. A slot 416 is defined between the elongate members 412.

The elongate members 412 each include a flat surface 402-1, 402-2 (referred to collectively as flat surfaces 402) facing the slot 416. The flat surfaces 402 each extend along one of planes 404-1, 404-2 (referred to collectively as planes 404). The planes 404 are each parallel to one another.

The pivot member may include multiple channels 422. At least one of the channels 422 may be configured to engage a rib of a heating chamber to prevent axial rotation of the tool 400 in the heating chamber.

FIGS. 19 and 20 show a tool 500 with ridged surfaces 502 facing the slot 516 according to embodiments described herein. FIG. 19 shows a bottom view of the tool 500. FIG. 20 shows an isometric exploded view of elongated members 512.

The tool 500 includes a tool base (not shown), a pivot member 520, a first elongate member 512-1, a second elongate member 512-2 (referred to collectively as elongate members 512), and a pivot member 520. The elongate members 512 extend from the tool base. The first elongate member 512-1 includes a first distal end 514-1 distal from the tool base 518 and the second elongate member 512-2 includes a second distal end 514-2 (referred to collectively as distal ends 514) distal from the tool base 518. A slot 516 is defined between the elongate members 512.

The elongate members 512 each include a ridge 502-1, 502-2 (referred to collectively as ridges 502). The ridges 502 extend into the slot 516. The ridges 502 may be configured to contact a heating blade when received into a heating chamber of an aerosol-generating device. The ridges 502 may be configured to rub the heating blade during a reciprocating motion of the tool 500. The ridges 502 may be formed of a material that will not damage the heating blade during the reciprocating movement.

The pivot member may include multiple channels 522. At least one of the channels 522 may be configured to engage a rib of a heating chamber to prevent axial rotation of the tool 500 in the heating chamber.

FIG. 21 shows another modification of the tool according to embodiments described herein. The tool 600 includes bristles 602.

The tool 600 includes a tool base 618, a first elongate member 612-1, a second elongate member 612-2 (referred to collectively as elongate members 612), and bristles 602. The elongate members 612 extend from the tool base 618. The first elongate member 612-1 includes a first distal end 614-1 distal from the tool base 618 and the second elongate member 612-2 includes a second distal end 614-2 (referred to collectively as distal ends 614) distal from the tool base 618. A slot 616 is defined between the elongate members 612. The bristles 602 extend from the elongate members 612. The bristles 602 may extend radially from the elongate members 612.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10 percent of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1. A tool for cleaning an aerosol-generating device having a heating chamber, the tool comprising:
a tool base;
a first elongate member extending from the tool base, the first elongate member comprising a first distal end distal from the tool base;
a second elongate member extending from the tool base, the second elongate member comprising a second distal end distal from the tool base,
wherein a slot is defined between the first elongate member and the second elongate member;
one or more elongate member protrusions operatively coupled to the first elongate member and one or more elongate member protrusions operatively coupled to the second elongate member and configured to cause the first elongate member and the second elongate member to move towards one another to reduce a width of the slot when a cleaning action is applied to the tool; and
a tubular member surrounding at least a portion of the first elongate member and the second elongate member,
wherein the tubular member further comprises one or more tubular member protrusions on an inner surface of the tubular member, each of the one or more tubular member protrusions configured to engage a corresponding one of the one or more elongate member protrusions.

2. The tool of claim 1, wherein the tubular member comprises a first semi-cylindrical shell and a second semi-cylindrical shell and wherein the first semi-cylindrical shell and second semi-cylindrical shell are configured to couple to one another to form a tube.

3. The tool of any one of claim 2, wherein the tubular member further comprises one or more channels on an outer surface of the tubular member, the one or more channels extending parallel to a longitudinal axis of the tubular member.

4. The tool of claim 1, wherein the one or more elongate member protrusions comprises:
a first pair of elongate member protrusions connected to each other by a first base and extending from the first elongate member, wherein elongate member protrusions of the first pair of elongate member protrusions are spaced apart by a first gap located adjacent to the base and between the elongate member protrusions of the first pair of elongate member protrusions; and
a second pair of elongate member protrusions connected to each other by a second base and extending from the second elongate member, wherein elongate member protrusions of the second pair of elongate member protrusions are spaced apart by a second gap located adjacent to the second base and between the elongate member protrusions of the second pair of elongate member protrusions.

5. The tool of claim 4, wherein at least one of the one or more elongate member protrusions are configured to engage with an inner wall of a heating chamber of an aerosol generating device.

6. The tool of claim 4, wherein the one or more tubular member protrusions comprise:
a first tubular member protrusion configured to engage the first pair of elongate member protrusions; and
a second tubular member protrusion configured to engage the second pair of elongate member protrusions.

7. The tool of claim 1, further comprising one or more pivot members arranged between the tool base and both the first distal end of the first elongate member and the second distal end of the second elongate member, wherein the one or more pivot members is configured to allow pivoting the first elongate member and the second elongate member in a preferred direction transverse to the extension of the first elongate member and wherein the one or more pivot members is configured to limit pivoting the first elongate member and the second elongate member in a non-preferred direction.

8. The tool of claim 1, wherein the first elongate member and the second elongate member are configured to pivot between a neutral position to a first pivoted position in the preferred direction or between a neutral position and a second pivoted position in the preferred direction, the first pivoted position and the second pivoted position being on opposite sides of the neutral position along the preferred direction.

9. The tool of claim 8, wherein an apex of the first tubular member protrusion is located in the first gap when the first elongate member and the second elongate member are in the neutral position and an apex of the second tubular member protrusion is located in the second gap in the neutral position.

10. The tool of claim 9, wherein the apex of the first tubular member protrusion is configured to engage one of the elongate member protrusions of the first pair of elongate member protrusions when the first elongate member is in the first or second position and the apex of the second tubular member protrusion is configured to engage one of the second pair of elongate member protrusions when the second elongate member is in the first or second position.

11. The tool of claim 1, wherein a surface facing the slot of the first elongate member and a surface facing the slot of the second elongate member are configured to engage opposite sides of an elongate heating element when the slot is narrowed while the tool is received in a heating chamber of an aerosol generating device.

12. The tool according to claim 7, wherein the one or more pivot members comprises an elliptical member defining an outer circumference with a channel configured to engage with a rib of the heating chamber to prevent axial rotation of the first elongate member and the second elongate member within the heating chamber.

13. The tool of claim 1, wherein the cleaning action comprises insertion of the tool into the heating chamber or comprises pivoting the first elongate member and the second elongate member in the preferred direction.

14. A system comprising:
an aerosol-generating device comprising a heating chamber and an elongate heating element with a substantially rectangular cross section extending into the heating chamber from a bottom chamber wall of a heating chamber; and
a tool for cleaning the aerosol-generating device according to claim 1.
